(19) United States
(12) Patent Application Publication
(10) Pub. No.: US 2015/0229701 A1
(43) Pub. Date: Aug. 13, 2015

(54) SENDING FILES WITH MULTIPLE JOB SESSIONS

(71) Applicant: Bank of America Corporation, Charlotte, NC (US)

(72) Inventors: Lerpong Bumroongpongse, Burbank, CA (US); John J. Smith, Plano, TX (US); Joan Lundholm, Flower Mound, TX (US); Gopalakrishnan Kaliamurthi, Chennai (IN)

(73) Assignee: Bank of America Corporation, Charlotte, NC (US)

(21) Appl. No.: 14/179,062

(22) Filed: Feb. 12, 2014

(51) Int. Cl. H04L 29/08

(52) U.S. Cl. CPC H04L 67/10

(57) ABSTRACT

A file transfer system and method for transferring large files to a destination quickly may include dividing up a large file into a plurality of components and transmitting the components simultaneously to the destination. A file can be separated into a plurality of segments and transmitted from a first module to a second module through a network simultaneously using multiple jobs corresponding to the segments. Once the second module receives the segments, the second module can implement a supply command to recreate the original saved file from the segments received from the first module. The simultaneous transmission of the segments may assist in transferring of the file at a faster rate.

### FIELD

Aspects of the disclosure generally relate to allowing a user to transfer large files to a destination quickly and efficiently. More specifically, aspects of the disclosure provides example methods and example apparatuses for dividing up a large file into a plurality of segments and transmitting the segments simultaneously to another destination.

### BACKGROUND

Files can be transferred from one host to another over a network such as the internet using various protocols such as HTTP or FTP and the like. In the case of larger file transfers, there may be a delay in transferring the file due to a number of factors, such as data buffer size, processing efficiency, and bandwidth. In certain instances, it may be desirous to increase the downloading speed of larger files.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

In an example method, a file can be separated into a plurality of segments. The plurality of segments can be transmitted from a first module to a second module through a network simultaneously using multiple jobs or job sessions corresponding to the number of segments. The simultaneous transmission of the segments may assist in the transferring of the file to the second module at a faster rate. Once the second module receives the segments, the second module can implement a supply command to recreate the original saved file from the segments received from the first module.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 illustrates one example of a network architecture and data processing device that may be used to implement one or more illustrative aspects discussed herein.

FIG. 2 illustrates a schematic of an exemplary process disclosed herein.

### DETAILED DESCRIPTION

In the following description of the various embodiments, reference is made to the accompanying drawings, which form a part hereof, and in which is shown by way of examples various examples in which the disclosure may be practiced. It is to be understood that other embodiments may be utilized and structural and functional modifications may be made without departing from the scope of the present disclosure. The disclosure is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning For example, the use of “including” and “comprising” and variations thereof is meant to encompass the items listed thereafter and equivalents thereof as well as additional items and equivalents thereof, and the use of the terms “mounted,” “connected,” “coupled,” “positioned,” “engaged” and similar terms, is meant to include both direct and indirect mounting, connecting, coupling, positioning and engaging.

As noted above, various aspects of the disclosure relate to sending files through multiple job sessions. Before discussing these aspects in greater detail, however, several examples of network architectures and data processing devices that may be used in implementing various aspects of the disclosure will first be discussed.

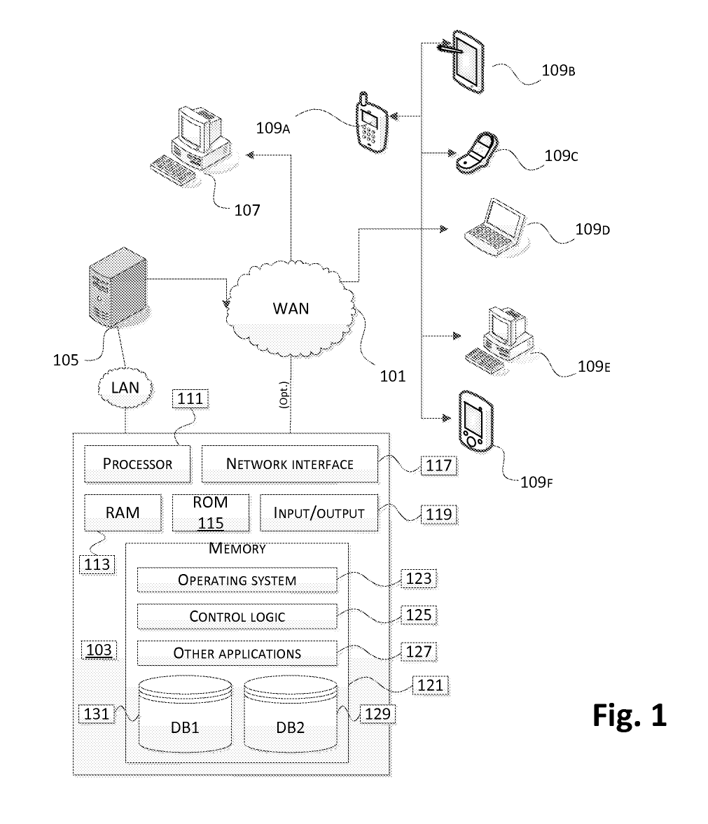

FIG. 1 illustrates one example of a network architecture and data processing device that may be used to implement one or more illustrative aspects. Various network nodes 103, 105, 107, and 109A-F may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109A-F and other devices (not shown) may be connected to one or more of the networks via twisted pair wires, coaxial cable, fiber optics, radio waves or other communication media. For example, the above connections can be made via the internet, blue tooth, WiFi, infrared, or any other known method of wireless transmission.

As shown in FIG. 1, devices 109A-F may include personal computers such as desktops, laptops, notebooks, mobile telephones or smartphones with applications and other functionality, a handheld device with Wi-Fi or other wireless connectivity (e.g., wireless enabled tablets, tablet computers, PDAs, and the like), displays with built-in or external memories and processors, or any other known computer, computing device, or handheld computer can also be connected to one or more of the networks described herein. It is also contemplated that other types of devices such as ATMs, kiosks, and other devices can be connected to one or more of the networks described herein. These devices can be enabled to communicate with wireless access points which in one example can be a series of cellular towers hosted by a service provider. Additionally, the wireless access points may be Wi-Fi (e.g., compatible with IEEE 802.11a/b/g/and the like wireless communication standards) connections and the computing devices may obtain access to the Internet at these connections. Other known techniques may be used to allow devices to connect with a network.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, and devices 109A-F. Data server 103 provides overall access, control and administration of databases and control software for performing one or more illustrative aspects as described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, devices 109A-F, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 or devices 109A-F a user may access web server 105 using an Internet browser, as is known in the art, or by executing a software application or app that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device as discussed herein. Data server 103, e.g., may include a processor 111 controlling overall operation of the rate server 103. Data server 103 may further include RAM 113, ROM 115, network interface 117, input/output interfaces 119 (e.g., keyboard, mouse, display, printer, or the like.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects as described herein, and other application software 127 providing secondary, support, and/or other functionality which may or may not be used in conjunction with one or more aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, or the like).

Memory 121 may also store data used in performance of one or more aspects, including a first database 129 and a second database 131. In some embodiments, the first database may include the second database (e.g., as a separate table, report, or the like). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109A-F) as described herein may be spread across multiple data processing devices, for example, to distribute processing load across multiple computers, to segregate transactions based on geographic location, user access level, quality of service (QoS), or the like.

One or more aspects may be embodied in computer-usable or readable data and/or computer-executable instructions, such as in one or more program modules, executed by one or more computers or other devices as described herein. Generally, program modules include routines, programs, objects, components, data structures, or the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, or the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

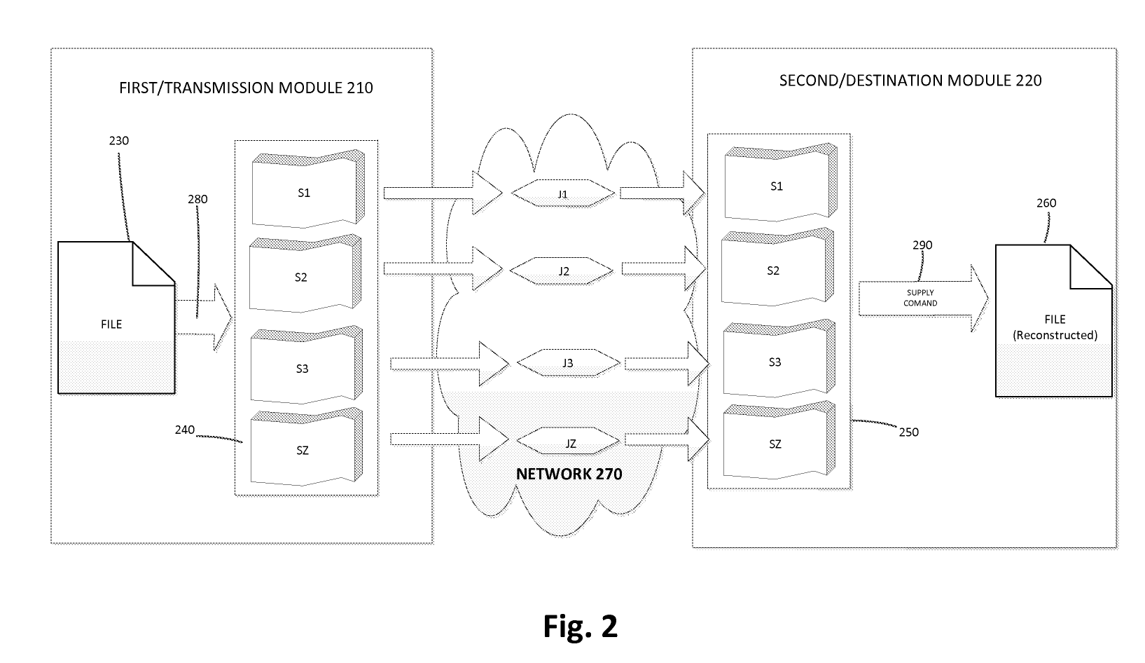

Aspects of an exemplary file transfer process will now be described in relation to FIG. 2. FIG. 2 depicts a schematic of an exemplary file transfer process where a first or transmission module 210 transmits a file 230 to a second or destination module 220. The first module 210 and the second module 220 can be a server or any computational device as discussed herein. The first module 210 can be configured as the transmission module 220, and the second module 220 can be configured as the destination module. The first module 210 can be located in a first location and the second module 220 can be located in a second location remote from the first location. It is readily understood that the second module 220 can also be configured to transmit files to the first module 210, and the first module 210 can be configured to receive files from the second module 220.

The first module 210 using a multi job utility 280 can be configured to divide up or separate the file into a plurality of segments (S₁, S₂ S₃ . . . S_{z}) depending on the number of jobs desired by the user. A transmission module buffer or memory 240 can be associated with the first module 210 for sending the segments (S₁, S₂ S₃ . . . S_{z}) to the second module 220. The first module 210 can be connected to a network 270, e.g. the internet and can be configured to send the segments (S₁, S₂, S₃ . . . S_{z}) simultaneously using an FTP protocol or any known protocol by way of multiple jobs (J₁, J₂, J₃ . . . J_{z}) or multiple threads to the second module 220. The number of jobs (J₁, J₂, J₃ . . . J_{z}) may correspond to the number of segments (S₁, S₂, S₃ . . . S_{z}). The second module 220 can be configured to receive each of the jobs (J₁, J₂, J₃ . . . J_{z}). A destination module buffer or memory 250 can also be associated with the second module 220, which can be configured to receive each of the segments (S₁, S₂, S₃ . . . S_{z}) from the jobs (J₁, J₂, J₃ . . . J_{z}). The second module 220 can be provided with a supply command to reconstruct or recreate the original saved file 260 from the segments.

The first module 210 or the transmission module transmits the file 230 to the second module 220 by splitting up the file into segments (S₁, S_{2,} S₃ . . . S_{z}). In one example, the first module 210 divides up the file into segments (S₁, S₂, S₃. . . S_{z}) based on the number of jobs selected by the user or based on a default setting. In another example, the first module 210 can be configured to determine how many segments the file should be separated into prior to transmitting each of the segments simultaneously. The segments (S₁, S₂, S₃ . . . S_{z}) are then transferred into the transmission module buffer 250 or memory for sending to the second module 220.

From the first module buffer 240 the segments (S₁, S₂, S₃ . . . S_{z}) are then transferred through a network 270, using jobs (J₁, J₂, J₃ . . . J_{z}) simultaneously using an FTP protocol or any known protocol to the second module 220. The simultaneous transmission of the segments (S₁, S₂, S₃ . . . S_{z}) helps increase the speed at which the file is transferred to the second module 220. The second module 220 receives each of the segments (S₁, S₂, S₃ . . . S_{z}) from the jobs (J₁, J₂, J₃ . . . J_{z}). Once the second module 220 receives each of the segments, the supply command 290 of the destination module then reconstructs the original saved file 260 from the segments (S₁, S₂, S₃ . . . S_{z}) and the file transfer is complete. In one example, the first module 210 can provide the supply command to the second module 220 either together with or separately from the segments (S₁, S₂, S₃ . . . S_{z}). This may also provide a secure transmission of the file 230 to the second module 220 in that the file cannot be reconstructed without the supply command.

The first module 220 can include or can be configured to run the multi job utility 280. The multi job utility 280 can be configured to split up the file into segments and simultaneously transfer the file to the second module 220 using, for example, an FTP protocol. The multi job utility 280 can also identify the files to the second module 220 and ascertain how may segments the file should be split into before transmitting to the destination module. The multi job utility can send the files in batch mode and has the ability to send larger files, which in one example can be 10 GB or larger. The multi job utility 280 can increase the rate at which the files are transferred by providing the ability to send the files in a single job or multiple jobs at the same time.

The multi job utility 280 can include a one-time configuration setup mode to apply base or default parameters for sending files to the second module 220. These parameters may include, for example, job description/library name, job queue/library name, and default number of segments. In one example, the number of segments can be three and can be changed to a maximum number of fifteen.

Additionally the multi job utility 280 can request a reference number for the file that is being transferred to the destination module. In this way, the destination module is able to associate the file with a particular matter. In one example, the file may be associated with a certain issue that can only be resolved by reviewing the particular file, and the reference number can be a problem management request or a problem maintenance request identifier. This number can be associated with a file detailing the performance. It may be advantageous to utilize the multi job utility in this setting such that the appropriate personnel can quickly review the file and diagnose the issue that is occurring. However, the multi job utility can be configured to transmit any large files. For example, large work documents, images, movies, music files, and the like can all be transferred using the multi job utility and the systems and processes discussed herein.

The multi job utility 280 can also be configured to request a prefix string which can be associated with the file name prefix, and the multi job utility can also include a server address, which can be an FTP server address. The server address can be the destination module address and can be the destination of the directory in which the file or files are to be placed. The multi-job utility 280 can also be configured to require a user authentication at the destination module.

The multi job utility 280 can be configured to display the status of the file transfer to the destination module. In this way the multi job utility 280 can be configured to display job status, definition, run attributes, spooled files, job logs, call stack, locks if active, library list if active, open files, if active, file overrides, if active, and commitment control status, if active. The attributes of the batch job can include certain information for the user such as status of the job, user profiles, job user identities, settings, date and time entered into the system, and date and time the job started.

Features of the example file transfer systems and methods set forth herein will now be described. An example file transfer method may include separating a file into a plurality of segments and transmitting from a first module to a second module through a network each of the plurality of segments using multiple jobs corresponding to the segments simultaneously. The method may also include determining how many segments the file should be separated into prior to transmitting each of the segments simultaneously or providing the user with a request for the number of segments to separate the file. In one example, the number of segments ranges from three to fifteen.

The method can also include providing the user with an option to select the second module. The first module can be located in a first location, and the second module can be located in a second location remote from the first location. The method can include providing the user with an option of submitting a problem management request identifier, providing the user with the option to select a remote IP address and the remote destination path.

In another example, a computer-implemented method of transferring a file from a first module to a second module may include determining a number of segments to separate the file into by the first module, separating a file into the number of segments by the first module, and transmitting from the first module to the second module each of the segments using multiple jobs simultaneously through a network. The number of segments may range from three to twelve or the method may include providing the user with a request for the number of segments to be used as a default setting. The first module is in a first location, and the second module is in a second location remote from the first location. The method may also include providing the user with the option of submitting a problem management request and providing the user with an option to select the second module.

Another example method may include separating a file into a number of segments and transmitting to a server each of the segments using multiple jobs simultaneously through a network. The number of segments can range from three to twelve. The method can include providing a user with an option to select the second module, providing the user with a request for the number of segments to be used as a default setting and providing the user with the option of submitting a problem management request. In one example, the number of segments is three in the default setting.

In another example, an apparatus comprising: a processor; and a memory for storing computer readable instructions that, when executed by the processor, can cause the apparatus to perform the methods discussed herein. In another example, one or more non-transitory computer-readable media may have instructions stored thereon that, when executed, cause at least one computing device to perform one or more aspects of the methods discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An apparatus comprising:
a processor; and
memory storing computer readable instructions that, when executed by the processor, cause the apparatus to:
separate a file into a plurality of segments; and
transmit from a first module to a second module through a network each of the plurality of segments using multiple jobs corresponding to the plurality of segments simultaneously.

2. The apparatus of claim 1 further comprising determining a number of the plurality segments of the file prior to separating the file into the plurality of segments.

3. The apparatus of claim 1 wherein the number of the plurality of segments ranges from three to fifteen.

4. The apparatus of claim 1 further comprising providing the user with an option to select the second module including a remote IP address and a remote destination path.

5. The apparatus of claim 1 further comprising providing the user with a request for the number of the plurality of segments.

6. The apparatus of claim 1 wherein the first module is in a first location and the second module is in a second location remote from the first location.

7. The apparatus of claim 1 further comprising providing the user with an option of submitting a problem management request identifier for the file.

8. A computer-implemented method of transferring a file from a first module to a second module comprising:
determining a number of segments to separate the file into by the first module;
separating the file into the number of segments determined by the first module; and
transmitting from the first module to the second module each of the segments using multiple jobs simultaneously through a network.

9. The method of claim 8 wherein the number of segments ranges from three to twelve.

10. The method of claim 8 further comprising providing the user with an option to select the second module.

11. The method of claim 8 further comprising providing the user with a request for the number of segments to be used as a default setting.

12. The method of claim 11 wherein the first module is in a first location and the second module is in a second location remote from the first location.

13. The method of claim 8 further comprising providing the user with the option of submitting a problem management request.

14. One or more non-transitory computer-readable media having instructions stored thereon that, when executed, cause at least one computing device to:
separate a file into a number of segments; and
transmit to a server each of the segments using multiple jobs simultaneously through a network.

15. The one or more non-transitory computer-readable media of claim 15 wherein the number of segments ranges from three to twelve.

16. The one or more non-transitory computer-readable media of claim 15 further comprising providing a user with an option to select the second module.

17. The one or more non-transitory computer-readable media of claim 19 further comprising providing the user with a request for the number of segments to be used as a default setting.

18. The one or more non-transitory computer-readable media of claim 17 further comprising providing the user with the option of submitting a problem management request.

19. The one or more non-transitory computer-readable media of claim 17 further comprising providing the user with a request for the number of the plurality of segments.

20. The one or more non-transitory computer-readable media of claim 17 further comprising providing the user with an option of submitting a problem management request identifier for the file.
